(19) United States
(12) Patent Application Publication
(10) Pub. No.: US 2016/0176326 A1
(43) Pub. Date: Jun. 23, 2016

(54) Seat Suspension System

(71) Applicant: Caterpillar Inc., Peoria, IL (US)

(72) Inventors: J. Chase Catton, Peoria, IL (US); Jason R. Dare, Peoria, IL (US); Lalit Deshpande, Dunlap, IL (US); John C. Spangler, JR., Pekin, IL (US); Mike Contratto, Peoria, IL (US); Steven D. Wetherell, Peoria, IL (US)

(73) Assignee: CATERPILLAR INC., Peoria, IL (US)

(21) Appl. No.: 14/579,199

(22) Filed: Dec. 22, 2014

(51) Int. Cl. B60N 2/50; B60N 2/38; B60N 2/52

(52) U.S. Cl. CPC B60N 2/505; B60N 2/522; B60N 2/38; B60N 2/502

(57) ABSTRACT

A seat suspension system for a machine is provided. The seat suspension system includes a lower housing, an upper housing and an intermediate support member arranged to support the upper housing. A height adjustment assembly is arranged between the intermediate support member and the upper housing. The height adjustment assembly includes a plurality of swing links arranged and configured to move the upper housing in an upward direction and a rearward direction relative to the intermediate support member. A suspension assembly is arranged between the lower housing and the intermediate support member and movably supporting the intermediate support member and the upper housing on the lower housing. The suspension assembly includes a first scissor arm and a second scissor arm pivotally connected to the first scissor arm.

### TECHNICAL FIELD

This patent disclosure relates generally to seat suspensions systems and, more particularly, to a seat suspension system that is configured to permit adjustment of the height of the suspension system.

### BACKGROUND

Machines, such as skid steer loaders, multi-terrain loaders, backhoe loaders, agricultural tractors, track-type tractors, articulated trucks, wheel loaders, off-road vehicles, dump trucks, and other types of construction, mining, and agricultural machinery are used for a variety of tasks requiring operator control. Typically, an operator controls these machines while seated in a seat located on the machine. Some tasks performed by these machines may require the operator to remain in the seat for an extended period of time. However, these machines often vibrate during operation, which may cause the operator to fatigue quickly. This can reduce the effectiveness of the operator and can lead to a reduction in the length of time the operator is able to operate the machine. Consequently, suspensions have been developed to reduce the vibrations passed from the operating machine to the seat of the operator.

Present seat suspension systems for machines typically include suspension arrangements for springing and damping movements incurred when forces are exerted on the seat during operation of the work machine. Although the damping movements may improve operator comfort, these systems generally offer a limited ability to adjust the seat for the height of the operator. For example, commonly owned U.S. Pat. No. 5,950,977 (“the '977 patent”) discloses a seat suspension system that is configured to maintain a substantially constant distance between an operator and a control pedal throughout a defined path of motion. However, the seat suspension system disclosed in the '977 patent only allows the height of the seat to be adjusted by extending upward the entire suspension system. Thus, the only way that the seat can be adjusted to accommodate the height of the operator is by adjusting the entire suspension system. However, such adjustments can influence the suspension systems ability to absorb and dampen forces applied on the seat during operation of the machine.

### SUMMARY

In one aspect, the disclosure describes a seat suspension system for a machine. The seat suspension system includes a lower housing having a front portion and a rear portion and an upper housing having a front portion and a rear portion. An intermediate support member is arranged to support the upper housing and having a front portion and a rear portion. A suspension assembly is arranged between the lower housing and the intermediate support member and movably supports the intermediate support member and the upper housing on the lower housing. The suspension assembly includes a first scissor arm and a second scissor arm pivotally connected to the first scissor arm. The first scissor arm has a first end pivotally connected to the front portion of the lower housing and a second pivotally connected to the rear portion of the intermediate support member. A first toggle linkage has an upper end that is pivotally connected to the front portion of the intermediate support member and a lower end pivotally connected to the second scissor arm. A second toggle linkage has an upper end pivotally connected to the rear potion of the lower housing and a lower end pivotally connected to the second scissor arm. The respective upper ends of the first and second toggle linkages are relatively closer to the upper housing than the respective lower ends of the first and second toggle linkages. The first and second toggle linkages are arranged and configured such that as the upper housing moves in an upward direction away from the lower housing the upper housing moves in a forward direction relative to the lower housing and the upper housing rotates relative to the lower housing such that the front portion of the upper housing moves in the upward direction away from the lower housing farther than the rear portion of the upper housing moves in the upward direction away from the lower housing.

In another aspect, the disclosure describes a seat suspension system for a machine. A lower housing has a front portion and a rear portion and an upper housing has a front portion and a rear portion. An intermediate support member is arranged to support the upper housing and has a front portion and a rear portion. A suspension assembly is arranged between the lower housing and the intermediate support member and movably supports the intermediate support member and the upper housing on the lower housing. The suspension assembly includes a first scissor arm and a second scissor arm pivotally connected to the first scissor arm. A height adjustment assembly is arranged between the intermediate support member and the upper housing. The height adjustment assembly includes a plurality of swing links each having a first end pivotally connected to the intermediate support member and a second end pivotally connected to the upper housing. The swing links are arranged and configured to move the upper housing in an upward direction and a rearward direction relative to the intermediate support member when pivoting in a first direction and to move the upper housing in a downward direction and a forward direction relative to the intermediate support member when pivoting in a second direction.

In yet another aspect, the disclosure describes a seat suspension system for a machine. The system includes a lower housing having a front portion and a rear portion and an upper housing having a front portion and a rear portion. An intermediate support member is arranged to support the upper housing and having a front portion and a rear portion. A height adjustment assembly is arranged between the intermediate support member and the upper housing. The height adjustment assembly includes a plurality of swing links arranged and is configured to move the upper housing in an upward direction and a rearward direction relative to the intermediate support member when pivoting in a first direction and to move the upper housing in a downward direction and a forward direction relative to the intermediate support member when pivoting in a second direction. A suspension assembly is arranged between the lower housing and the intermediate support member and movably supports the intermediate support member and the upper housing on the lower housing. The suspension assembly includes a first scissor arm and a second scissor arm pivotally connected to the first scissor arm. The first scissor arm has a first end pivotally connected to the front portion of the lower housing and a second end pivotally connected to the rear portion of the intermediate support member. A first toggle linkage is connected to a first end of the second scissor arm and a front portion of the intermediate support member. A second toggle linkage is pivotally connected to a second end of the second scissor arm and the rear portion of the lower housing. The first and second toggle linkages are arranged and configured such that as the upper housing moves in an upward direction away from the lower housing the upper housing moves in a forward direction relative to the lower housing and the upper housing rotates relative to the lower housing such that the front portion of the upper housing moves in the upward direction away from the lower housing farther than the rear portion of the upper housing moves in the upward direction away from the lower housing.

### BRIEF DESCRIPTION OF THE DRAWINGS

FIG. 1 is a perspective view of a portion of an exemplary operator cab of a machine.

FIG. 2 is a side view of a seat suspension system according to the present disclosure.

FIG. 3 is a front isometric view of the seat suspension system of FIG. 2.

FIG. 4 is a side view of the seat suspension system of FIG. 2 with the suspension assembly in a collapsed position and the height adjustment assembly in a low position.

FIG. 5 is a side view of the seat suspension system of FIG. 2 with the suspension assembly in a mid height position.

FIG. 6 is a side view of the seat suspension system of FIG. 2 with the suspension assembly in an extended position.

FIG. 7 is a side view of the seat suspension system of FIG. 2 with the height adjustment assembly in an intermediate position.

FIG. 8 is a side view of the seat suspension system of FIG. 2 with the height adjustment assembly in a high position.

FIG. 9 is a front isometric view of the seat suspension system of FIG. 2 looking upward.

FIG. 10 is a front isometric view of the seat suspension system of FIG. 2 looking upward.

### DETAILED DESCRIPTION

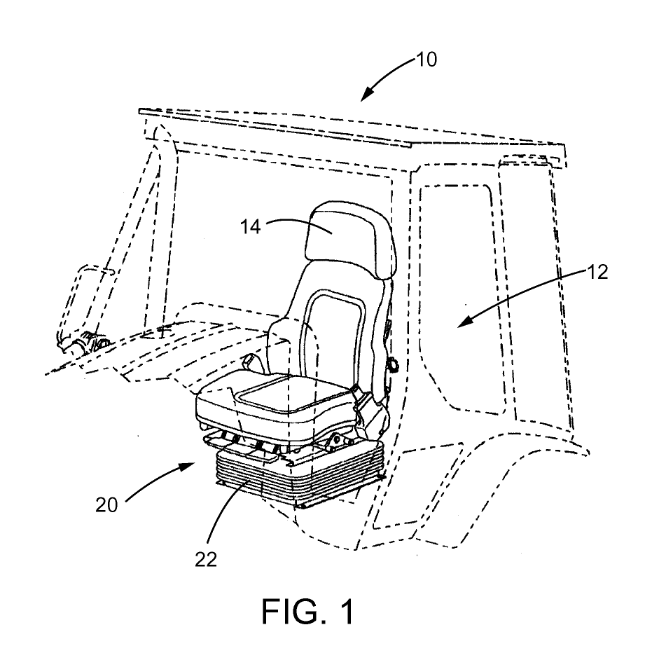

This disclosure generally relates to a suspension system for a seat of a machine. Referring to FIG. 1, a perspective view illustrates a portion of an exemplary machine 10 that includes an operator cab 12. The machine 10 may be a backhoe loader, agricultural tractor, track-type tractor, articulated truck, wheel loader, and other types of construction, mining, or agricultural machinery. As shown, the cab 12 may include a seat 14 mounted on a seat suspension system 20. The seat suspension system 20 may be attached to the machine 10 and be configured to dampen the vibrations associated with the operation of the machine 10 in order to increase operator comfort while seated in the seat 14.

The seat suspension system 20 may include a shroud 22 that conforms to the movement of the seat suspension system 20. The shroud 22 may help prevent contaminates such as water, dirt, rocks and other objects from affecting the performance of the seat suspension system 20. The shroud 22 may be made of cloth, an elastomer or other plastic, and any other material known in the art, that moves with the actuation of the seat suspension system 20.

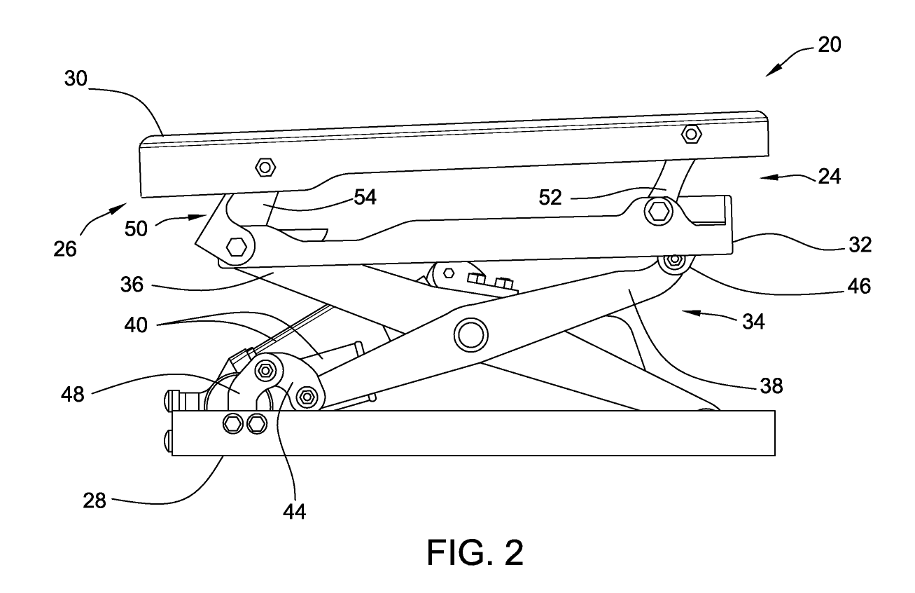

With reference to FIG. 2, an example of the seat suspension system 20 according to the present disclosure is shown. For ease of reference, the seat suspension system 20 may have a front end 24, which is the end that is arranged closest to any pedals and/or other controls when the seat suspension system 20 is installed in a machine. Additionally, the seat suspension system 20 may have a rear end 26, which is the end farthest from the pedals and/or other controls when the seat suspension system 20 is installed in a machine. The seat suspension system 20 may include a lower housing 28 and an upper housing 30, which is spaced vertically upward from the lower housing 28. The lower housing 28 may be used, for example, to mount the seat suspension system 20 to the floor of the cab of a machine. The lower housing 28 may, for example, include mounting holes that facilitate the attachment of the lower housing 28 to the machine, such as using bolts. The upper housing 30 may be configured for attachment to a seat. While an exemplary seat configuration is shown in FIG. 1, it will be understood by those skilled in the art, that the seat suspension system 20 of the present disclosure can be used with seats having a wide variety of different configurations. As shown in FIG. 2, an intermediate support member 32 that supports the upper housing 30 may be arranged between the lower housing 28 and the upper housing 30.

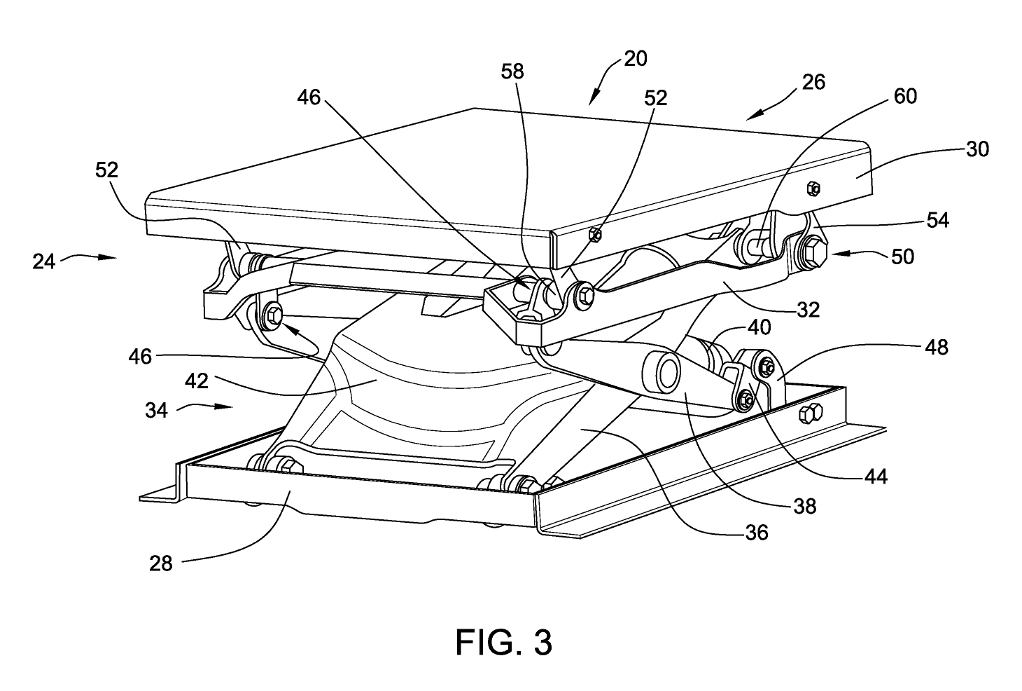

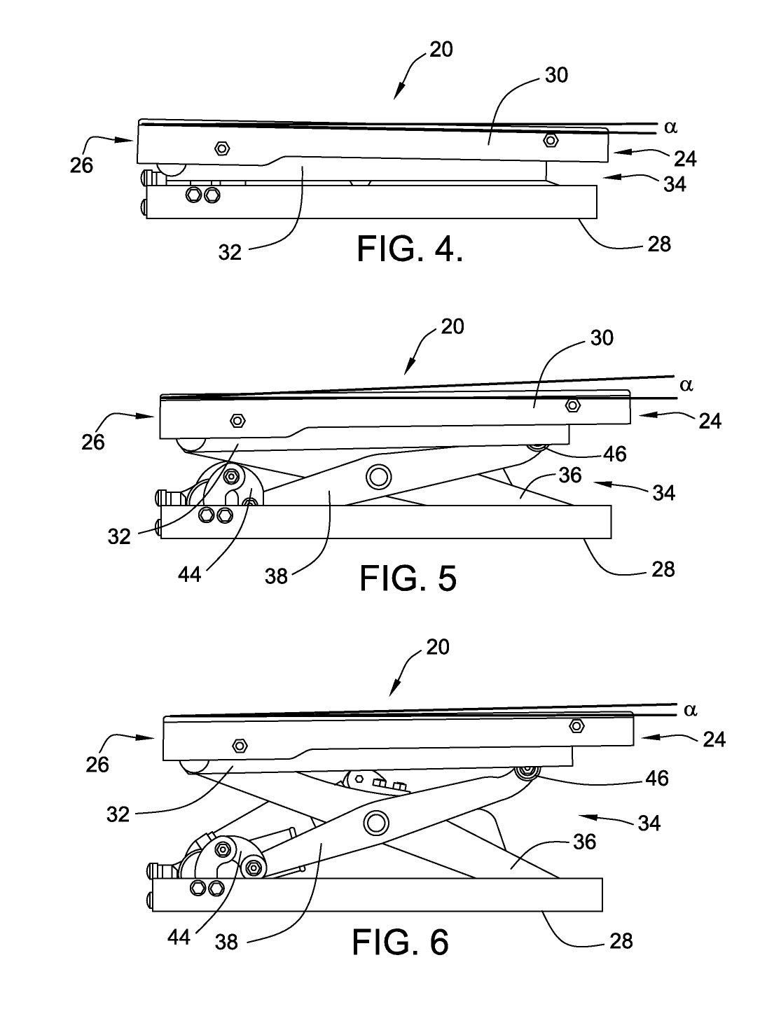

In order to isolate an operator sitting on a seat mounted to the upper housing 30 from vibrations and other movements resulting from operation of the machine, the seat suspension system 20 may include a suspension assembly 34. More particularly, the suspension assembly 34 may be configured to offset the static mass of the operator, provide isolation to the operator and/or to move based on inputs received from the operator or other systems that may be provided in the cab. The suspension assembly 34 may extend between the lower housing 28 and the intermediate support member 32 and may include an inner scissor arm 36 and an outer scissor arm 38 on each of the lateral sides of the seat suspension system 20 that can permit movement of the upper housing 30 relative to the lower housing 28. One set of inner and outer scissor arms 36, 38 is visible in FIG. 2 and a portion of the set of scissor arms 36, 38 on the opposing lateral side of the suspension assembly 34 is visible in FIGS. 3 and 4. The set of inner and outer scissor arms 36, 38 on the opposite lateral side of the suspension assembly 34 from that shown in FIG. 2 is identical to the set shown in FIG. 2.

The inner and outer scissor arms 36, 38 are arranged so as to cross each other and are pivotally attached to each other generally in the middle so as to provide a scissors configuration. More particularly, the inner and outer scissor arms 36, 38 may share a common pivot that may be received in respective openings near the center of each of the inner and outer scissor arms 36, 38. The outer scissor arm 38 may extend upward and forward from near the rear end 26 of the lower housing 28 to near the front end 24 of the intermediate support member 32. In contrast, the inner scissor arm 36 may extend upward and rearward from near the front end 24 of the lower housing 28 to near the rear end 26 of the intermediate support member 32. It will be appreciated that the inner and outer scissor arms 36, 38 could be arranged in the opposite configuration.

The suspension assembly 34 may also include one or more dampers 40 arranged to dampen motion of the upper housing 30 with respect to the lower housing 28. For example, the illustrated suspension assembly 34 includes a pair of dampers 40 each of which has a first end pivotally attached to the lower housing 28 and a second end pivotally attached to a cross-member 42 that extends between the inner scissor arms 36 arranged on each side of the suspension assembly 34. The cross member 42 may be integral with the inner scissor arms to provide added strength thereto and may be configured to conceal and/or cover the dampers 40 and other components associated with the seat suspension system. Each of the dampers may comprise a cylinder housing from which extends a cylinder rod. The cylinder housing may include a biasing element such as a compressible fluid or gas or a spring that can help absorb and dampen the motion of the upper housing 30 with respect to the lower housing 28. Those skilled in the art will appreciate that only a single damper or three or more dampers may be used. Similarly, it will be appreciated that the one or more dampers may have different configurations and mounting arrangements so long as they are able to dampen relative movement between the lower housing 28 and the upper housing 30.

The suspension assembly 34 may be configured such that as the upper housing 30 moves upward relative to the lower housing 28, the suspension assembly 34 also moves the upper housing 30 forward and rotates the upper housing 30 such that the front end 24 of the upper housing 30 moves further upward relative to the lower housing 28 more than the rear end 26 of the upper housing 30. An example of the movement of the intermediate support member 32 and the upper housing 30 relative to the lower housing 28 can be seen in FIGS. 4-6. In FIGS. 4-6, the suspension assembly 34 is shown in different vertical positions that vary the height of the upper housing 30 relative to the lower housing 28. More specifically, the suspension assembly 34 is shown in collapsed height, mid height and extended height positions respectively in FIGS. 4, 5 and 6. These different positions, as well as other intermediate positions between the collapsed height position and the extended height position, may be used in order to adjust the suspension assembly 34 to accommodate the available installation space in a variety of different machines including for retrofits into different existing machines.

With respect to the forward and rotary movement of the upper housing 30 relative to the lower housing 28, the suspension assembly 34 may be configured such that in the collapsed height position the upper housing extends in a plane that has a negative angle a with respect to a horizontal plane (e.g., a plane that extends parallel to the lower frame) as shown in FIG. 4. As shown in FIG. 5, as it moves between the collapsed height position and the mid height position, the suspension assembly 34 has rotated the upper housing 30 relative to the lower housing 28 in a direction that moves front end 24 of the upper housing 30 further upward away from the lower housing 28 such that the upper housing 30 extends in a plane that now has a positive angle a with respect to the horizontal plane. Additionally, the suspension assembly 34 has moved the upper housing 30 in the forward direction relative to the lower housing 28. Likewise, when the suspension assembly 34 moves to the extended height position as shown in FIG. 6, the upper housing 30 continues to extend in a plane that is at positive angle a with respect to the horizontal plane while the front end 24 of the upper housing 30 has moved even further forward relative to the lower housing 28. While FIGS. 4-6 provide one example of the movement of the upper housing 30 that may be implemented by the suspension assembly 34, it will be appreciated that the magnitude and path of the movement may be adjusted as desired, for example, to accommodate the dimensions of different machines.

The movement of the upper housing 30 shown in FIGS. 4-6 may be provided by providing toggle linkages at the front and rear ends of the suspension assembly 34. In particular, the outer scissor arm 38 of the scissor arrangement on each side of the suspension assembly 34 may be connected to a lower rear toggle linkage 44 at the rear end 26 of the scissor arm and to an upper front toggle linkage 46 at the front end 24 of the outer scissor arm 38. With respect to the upper front toggle linkage 46, the outer scissor arm 38 may be pivotally connected to a lower end to the upper front toggle linkage 46 while an upper end of the toggle linkage is pivotally connected to the intermediate support frame 32. At the lower rear toggle linkage 44, the outer scissor arm 38 may be pivotally connected to a lower end of the lower rear toggle linkage 44, which in the illustrated embodiment consists of a generally arc shaped link, while an upper end of the toggle linkage is pivotally connected to a rigid flange 48 extending upward from the lower housing 28. Thus, the lower rear toggle linkage 44 has an inverted configuration in which the upper end of the toggle linkage is pivotally connected to the lower housing 30 (through the flange 48) and the lower end of the toggle linkage is pivotally connected to the outer scissor arm 38. As shown for example in FIGS. 4-6, the lower end of the arc-shaped lower rear toggle linkage 44 may move away from and upward (in a generally counter clockwise direction with reference to the drawings) relative to where the flange 48 connects to the lower housing 28 as the upper housing 30 moves upward relative to the lower housing. This inverted toggle arrangement may produce the rotational movement of the upper housing 30 relative to the lower housing 28 during upward and downward movement of the suspension assembly 34. Additionally, arranging toggle linkages at opposite ends of the suspension assembly 34 may provide the forward and rearward movement of the upper housing 30 relative to the lower housing 28 as the suspension assembly 34 moves upward and downward.

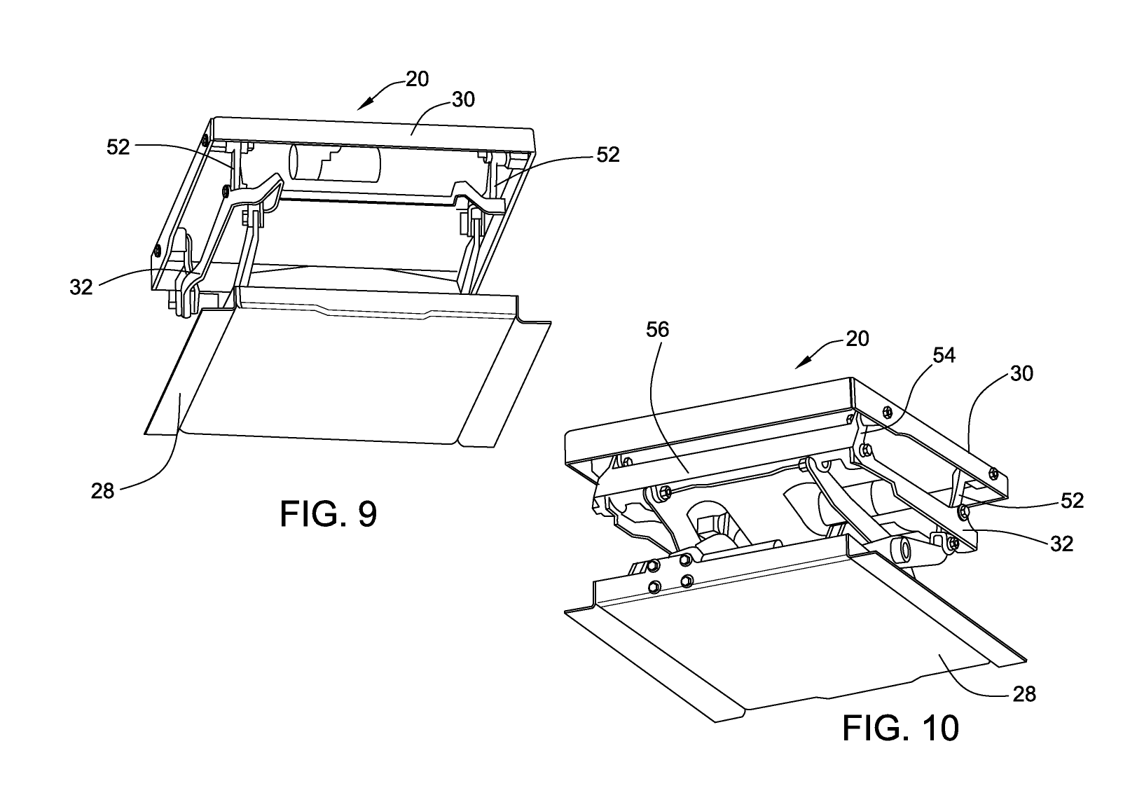

In order to allow for adjustment of the height of the upper housing 30 relative to the lower housing 28 independent of any movement of the suspension assembly 34, the seat suspension system 20 may include a height adjustment assembly 50. More particularly, the height adjustment assembly 50 may be configured such that the height of the seat assembly may be adjusted regardless of whether the suspension assembly 34 is in the collapsed height, mid height or extended height position. As shown in FIG. 2, the height adjustment assembly 50 may include a set of front swing links 52 extending between the intermediate support member 32 and the upper housing 30 near the front end 24 of either lateral side of the seat suspension system 20 and a set of rear swing links 54 extending between the intermediate support member 32 and the upper housing 30 near the rear end 26 of either side of the seat suspension system 20. The lower end of each front and rear swing link 52, 54 may be pivotally connected to the intermediate support member 32 while the upper end may be pivotally connected to the upper housing 30. The front and rear swing links 52, 54 on only one side of the seat suspension system 20 are visible in FIG. 2, however, the swing links 52, 54 on the opposite side of the seat suspension system 20 may be seen in the front and end views of FIGS. 9 and 10 respectively. As shown in FIG. 9, the two front swing links 52 may comprise separate elements. However, as shown in FIG. 10, the rear swing links 54 may be connected to each other via a cross piece 56. Such an arrangement may provide additional stability and strength for the height adjustment assembly 50.

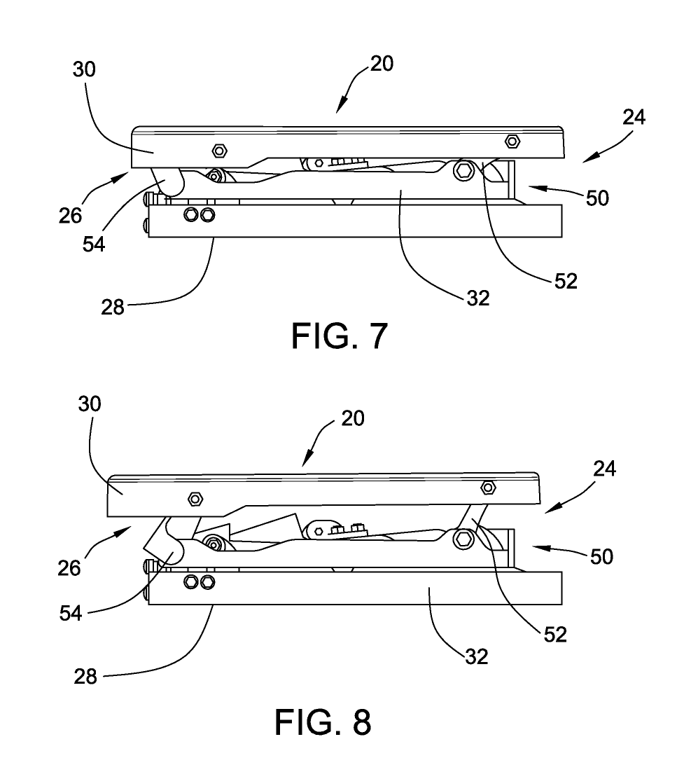

The front and rear swing links 52, 54 may be arranged and configured so as to move the upper housing 30 upward and rearward relative to the intermediate support member 32 when pivoted in a first direction (in this case counterclockwise) as shown in FIGS. 4, 7 and 8, with FIG. 4 showing a low position, FIG. 7 showing an intermediate position and FIG. 8 showing a high position. The upward and rearward movement provided by the front and rear swing links 52, 54 may be simultaneous in contrast to one movement following completion of the other movement (e.g., upward movement followed by rearward movement). Likewise, with such a configuration, the front and rear swing links 52, 54 can move the upper housing 30 downward and forward relative to the intermediate support member when pivoted in a second direction (in this case clockwise) opposite the first direction. Again, the downward and forward movement provided by the front and rear swing links 52, 54 may be simultaneous. Thus, the height adjustment assembly 50 may allow an operator to move the upper housing 30 and with it the seat up and away from, for example, the pedals and/or other controls in the cab of the machine independently of any adjustment of the suspension assembly 34 that may occur, for example, as a result of the weight of the operator. Likewise, the height adjustment assembly 50 can allow a shorter operator to move the upper housing 30, and seat, downward and closer to the pedals and/or other controls, again independent of any adjustment in the suspension assembly 34. According to one embodiment, the height adjustment assembly 50 may be configured such the front and rear swing links 52, 54 may be locked into position by a locking mechanism and are only moveable when the operator seeks to adjust the height of the seat. Further, a drive mechanism may be provided, such as for example an electric motor or screw drive, that may power the pivoting movement of the swing links and the movement of the upper housing. The drive mechanism, for example, could connect between the upper housing 30 and the intermediate support member 32. The locking mechanism may be combined with the drive mechanism or provided separately.

The upper front toggle linkage 46 and the front swing link 52 may be configured so as to share a common pivot 58 on the intermediate support member 32 on each side of the seat suspension system as shown in FIG. 3. Additionally, the inner scissor arm 36 and the rear swing link 54 may share a common pivot 60 to the intermediate support member 32 on each side of the seat suspension system (one side is visible in FIG. 3). Such a configuration may minimize wasted space and may help reduce the overall height of the seat suspension system 20.

### INDUSTRIAL APPLICABILITY

The seat suspension system 20 of the present disclosure may be applicable to any type of machine having a seat, particularly a seat from which an operator may manipulate pedals or other controls to direct operation of the machine. The seat suspension system 20 can be adjusted to fit the available space on machines have a variety of different configurations. As a result, the seat suspension system can be used across a number of different types and sizes of machines and can be retrofit into a variety of different types of existing machines. Additionally, the suspension assembly 34 of the seat suspension system 20 may provide forward movement of the upper housing 30 attached to the seat as the upper housing moves upward that may allow an operator to maintain a desirable distance to the machine controls as the seat is moving. The suspension assembly 34 also may rotate the upper housing 30 rearward as it moves upward to help limit any lurching forward feeling that an operator may have when the seat moves upward.

Moreover, the height adjustment assembly 50 of the seat suspension system 20 may provide upward and rearward movement that can allow taller operators to achieve a more comfortable position relative to the pedals and other controls of the machine. The height adjustment movement may be independent of any movement of the suspension assembly 34.

It will be appreciated that the foregoing description provides examples of the disclosed system and technique. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A seat suspension system for a machine comprising:
a lower housing having a front portion and a rear portion;
an upper housing having a front portion and a rear portion;
an intermediate support member arranged to support the upper housing and having a front portion and a rear portion;
a suspension assembly arranged between the lower housing and the intermediate support member and movably supporting the intermediate support member and the upper housing on the lower housing, the suspension assembly comprising:
a first scissor arm and a second scissor arm pivotally connected to the first scissor arm, the first scissor arm having a first end pivotally connected to the front portion of the lower housing and a second end pivotally connected to the rear portion of the intermediate support member;
a first toggle linkage having an upper end that is pivotally connected to the front portion of the intermediate support member and a lower end pivotally connected to the second scissor arm;
a second toggle linkage having an upper end pivotally connected to the rear potion of the lower housing and a lower end pivotally connected to the second scissor arm, the respective upper ends of the first and second toggle linkages being relatively closer to the upper housing than the respective lower ends of the first and second toggle linkages,
wherein the first and second toggle linkages are arranged and configured such that as the upper housing moves in an upward direction away from the lower housing the upper housing moves in a forward direction relative to the lower housing and the upper housing rotates relative to the lower housing such that the front portion of the upper housing moves in the upward direction away from the lower housing farther than the rear portion of the upper housing moves in the upward direction away from the lower housing; and
a height adjustment assembly arranged between the intermediate support member and the upper housing, the height adjustment assembly including a plurality of swing links arranged and configured to move the upper housing in an upward direction and a rearward direction relative to the intermediate support member when pivoting in a first direction and to move the upper housing in a downward direction and a forward direction relative to the intermediate support member when pivoting in a second direction,
wherein the plurality of swing links each having a first end pivotally connected to the intermediate support member and a second end pivotally connected to the upper housing, and the plurality of swing links include a pair of front swing links each arranged on a lateral side of the seat suspension system and extending between the front portion of the intermediate support member and the front portion of the upper housing and a pair of rear swing links each arranged on one of the lateral sides of the seat suspension system and extending between the rear portion of the intermediate support member and the rear portion of the upper housing.

2.-4. (canceled)

5. The seat suspension system of claim 1 wherein the front swing links are separate elements.

6. The seat suspension system of claim 1 wherein the rear swing links are interconnected by a cross piece.

7. The seat suspension system of claim 1 wherein the suspension assembly includes a set of first and second scissor arms on each of the lateral sides of the seat suspension system.

8. The seat suspension system of claim 1 wherein the first scissor arm shares a pivot at the intermediate support member with one of the rear swing links and the upper end of the first toggle linkage shares a pivot at the intermediate support member with one of the front swing links.

9. The seat suspension system of claim 1 wherein the upper end of the second toggle linkage is pivotally connected to the rear portion of the lower housing through a flange that extends upward from an upper surface of the lower housing.

10. The seat suspension system of claim 1 further including a damper arranged and configured to dampen movement of the upper housing relative to the lower housing.

11. A seat suspension system for a machine comprising:
a lower housing having a front portion and a rear portion;
an upper housing having a front portion and a rear portion;
an intermediate support member arranged to support the upper housing and having a front portion and a rear portion;
a suspension assembly arranged between the lower housing and the intermediate support member and movably supporting the intermediate support member and the upper housing on the lower housing, the suspension assembly including a first scissor arm and a second scissor arm pivotally connected to the first scissor arm; and
a height adjustment assembly arranged between the intermediate support member and the upper housing, the height adjustment assembly including a plurality of swing links each having a first end pivotally connected to the intermediate support member and a second end pivotally connected to the upper housing, the swing links being arranged and configured to move the upper housing in an upward direction and a rearward direction relative to the intermediate support member when pivoting in a first direction and to move the upper housing in a downward direction and a forward direction relative to the intermediate support member when pivoting in a second direction,
wherein the plurality of swing links include a pair of front swing links each arranged on a lateral side of the seat suspension system and extending between the front portion of the intermediate support member and the front portion of the upper housing and a pair of rear swing links each arranged on one of the lateral sides of the seat suspension system and extending between the rear portion of the intermediate support member and the rear portion of the upper housing.

12. (canceled)

13. The seat suspension system of claim 11 wherein the front swing links are separate elements and wherein the rear swing links are interconnected by a cross piece.

14. The seat suspension system of claim 11 wherein the first scissor arm has a first end pivotally connected to the front portion of the lower housing and a second end pivotally connected to the rear portion of the intermediate support member and the suspension assembly further includes a first toggle linkage connected to a first end of the second scissor arm and a front portion of the intermediate support member and a second toggle linkage pivotally connected to a second end of the second scissor arm and the rear portion of the lower housing.

15. The seat suspension system of claim 14 wherein the first scissor arm shares a pivot at the intermediate support member with one of the rear swing links and the upper end of the first toggle linkage shares a pivot at the intermediate support member with one of the front swing links.

16. A seat suspension system for a machine comprising:
a lower housing having a front portion and a rear portion;
an upper housing having a front portion and a rear portion;
an intermediate support member arranged to support the upper housing and having a front portion and a rear portion;
a height adjustment assembly arranged between the intermediate support member and the upper housing, the height adjustment assembly including a plurality of swing links arranged and configured to move the upper housing in an upward direction and a rearward direction relative to the intermediate support member when pivoting in a first direction and to move the upper housing in a downward direction and a forward direction relative to the intermediate support member when pivoting in a second direction; and
a suspension assembly arranged between the lower housing and the intermediate support member and movably supporting the intermediate support member and the upper housing on the lower housing, the suspension assembly comprising:
a first scissor arm and a second scissor arm pivotally connected to the first scissor arm, the first scissor arm having a first end pivotally connected to the front portion of the lower housing and a second end pivotally connected to the rear portion of the intermediate support member;
a first toggle linkage pivotally connected to a first end of the second scissor arm and a front portion of the intermediate support member; and
a second toggle linkage pivotally connected to a second end of the second scissor arm and the rear portion of the lower housing;
wherein the first and second toggle linkages are arranged and configured such that as the upper housing moves in an upward direction away from the lower housing the upper housing moves in a forward direction relative to the lower housing and the upper housing rotates relative to the lower housing such that the front portion of the upper housing moves in the upward direction away from the lower housing farther than the rear portion of the upper housing moves in the upward direction away from the lower housing,
wherein the plurality of swing links include a pair of front swing links each arranged on a lateral side of the seat suspension system and extending between the front portion of the intermediate support member and the front portion of the upper housing and a pair of rear swing links each arranged on one of the lateral sides of the seat suspension system and extending between the rear portion of the intermediate support member and the rear portion of the upper housing.

17. (canceled)

18. The seat suspension system of claim 16 wherein the front swing links are separate elements and wherein the rear swing links are interconnected by a cross piece.

19. The seat suspension system of claim 14 wherein the first scissor arm shares a pivot at the intermediate support member with one of the rear swing links and the first toggle linkage shares a pivot at the intermediate support member with one of the front swing links.

20. The seat suspension system of claim 16 further including a damper arranged and configured to dampen movement of the upper housing relative to the lower housing.
